(19) United States
(12) Patent Application Publication
(10) Pub. No.: US 2011/0085761 A1
(43) Pub. Date: Apr. 14, 2011

(54) ARRAYED WAVEGUIDE GRATING AND METHOD OF MANUFACTURING ARRAYED WAVEGUIDE GRATING

(75) Inventors: Kazutaka NARA, Tokyo (JP); Yasuyoshi Uchida, Tokyo (JP); Noritaka Matsubara, Tokyo (JP)

(73) Assignee: FURUKAWA ELECTRIC CO., LTD., Tokyo (JP)

(21) Appl. No.: 12/973,327

(22) Filed: Dec. 20, 2010

Related U.S. Application Data
(63) Continuation-in-part of application No. 12/787,096, filed on May 25, 2010.

(30) Foreign Application Priority Data
May 26, 2009 (JP) 2009-126096
Aug. 2, 2010 (JP) 2010-173823

(51) Int. Cl. G02B 6/34; G02B 1/12

(52) U.S. Cl. 385/37; 264/1.27

(57) ABSTRACT

An arrayed waveguide grating includes: at least one first waveguide; a first slab waveguide connected to the at least one first waveguide; a plurality of second waveguides; a second slab waveguide connected to the plurality of second waveguides; and an arrayed waveguide. The arrayed waveguide includes: M channel waveguides connected between the first slab waveguide and the second slab waveguide, wherein M is a natural number; and a phase correcting portion configured to provide a predetermined phase to at least a part of the M channel waveguides by one or both of a width and a length of the at least the part of the M channel waveguides being changed.

### CROSS-REFERENCE TO RELATED APPLICATIONS

This application is a continuation-in-part of U.S. application Ser. No. 12/787,096 filed on May 25, 2010, and is based upon and claims the benefit of priority from Japanese Application No. 2010-173823 filed on Aug. 2, 2010, the entire contents of which are incorporated herein by reference. U.S. application Ser. No. 12/787,096 is based upon and claims the benefit of priority from Japanese Application No. 2009-126096 filed on May 26, 2009, the entire contents of which are also incorporated herein by reference.

### BACKGROUND OF THE INVENTION

1. Field of the Invention

The present invention relates to an arrayed waveguide grating and a method of manufacturing the arrayed waveguide grating.

2. Description of the Related Art

Arrayed waveguide gratings (AWGs) may be roughly classified into two types. One type is Gaussian-type AWGs having transmission spectra of a Gaussian-function form, and flat-type AWGs having transmission spectra of a flat form. For flat-type AWGs, various characteristics are demanded, like high flatness of the transmission spectra, no being sloped, wavelength dispersion of nearly zero, and low side-to-side crosstalk.

However, when AWGs are actually manufactured, errors in the manufacture lead to degradation in the characteristics. AWGs are basically configured such that the length of each of channel waveguides of each arrayed waveguide increases by a constant pitch (an optical path length difference ΔL). However, in practice, the optical path length difference ΔL between the channel waveguides of the manufactured arrayed waveguide slightly deviates from a design value. This deviation from the design value leads to a phase error. The phase error generated in each channel waveguide of an arrayed waveguide is a cause of crosstalk or the like between channels and degrades the characteristics of the AWG.

As means for adjusting such degradation in the characteristics, Japanese Laid-open Patent Publication No. 2001-249243 and Japanese Laid-open Patent Publication No. 2003-240984 propose a method of making a correction, in which a phase error in each channel waveguide of an arrayed waveguide of a manufactured AWG is actually measured individually, a metal mask for correcting the phase error based on a result of the measurement is manufactured each time, and ultraviolet radiation is irradiated through the metal mask, to increase the refractive index of the channel waveguide according to the phase error.

However, although the above conventional method achieves an ideal transmission spectrum form, it is necessary to manufacture a metal mask for correcting a phase error individually for each manufactured AWG chip, which makes mass production difficult. Further, depending on the accuracy of alignment between the metal mask for correcting the phase error and the chip, the characteristics of the AWG may change.

### SUMMARY OF THE INVENTION

It is an object of the present invention to at least partially solve the problems in the conventional technology.

According to an aspect of the present invention, an arrayed waveguide grating includes: at least one first waveguide; a first slab waveguide connected to the at least one first waveguide; a plurality of second waveguides; a second slab waveguide connected to the plurality of second waveguides; and an arrayed waveguide. The arrayed waveguide includes: M channel waveguides connected between the first slab waveguide and the second slab waveguide, wherein M is a natural number; and a phase correcting portion configured to provide a predetermined phase to at least a part of the M channel waveguides by one or both of a width and a length of the at least the part of the M channel waveguides being changed.

According to another aspect of the present invention, in the arrayed waveguide grating, the M channel waveguides include a first phase correcting portion for fine adjustment and a second phase correcting portion for fine adjustment, each of the first and second phase correcting portions for fine adjustment includes a wide waveguide having a width wider than a basic waveguide width in a part or all of the M channel waveguides, the predetermined phase is adjusted by one or both of a length and a width of the wide waveguide being changed, and each of the lengths of the wide waveguides of the first and second phase correcting portions for fine adjustment is defined such that a sum of phases provided by the first and second phase correcting portions for fine adjustment becomes zero.

According to still another aspect of the present invention, a method of manufacturing the arrayed waveguide grating includes: preparing the arrayed waveguide grating; and performing UV irradiation on the phase correcting portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plane view of an arrayed waveguide grating according to a first embodiment of the present invention;

FIG. 2A is a schematic diagram of a structure of a phase correcting portion of the arrayed waveguide grating illustrated in FIG. 1 together with a phase distribution provided by the phase correcting portion, and FIG. 2B is an explanatory view of one channel waveguide of an arrayed waveguide in the phase correcting portion illustrated in FIG. 2A;

FIG. 3 is a plane view of a part of a photomask used in manufacturing the arrayed waveguide grating according to the first embodiment;

FIG. 4A is a schematic diagram of a phase correcting portion of an arrayed waveguide grating according to a second embodiment of the present invention together with a phase distribution provided by the phase correcting portion, and FIG. 4B is an explanatory view of one channel waveguide of an arrayed waveguide in the phase correcting portion illustrated in FIG. 4A;

FIG. 5A is a graph indicating transmission spectra of 50 GHz-80 ch flat-type AWGs (i.e., three AWG chips, A, B and C) manufactured using a conventional photomask and a transmission spectrum of design values, and FIG. 5B is a graph representing the top portions of the transmission spectra illustrated in FIG. 5A;

FIG. 6A is a graph indicating transmission spectra of 50 GHz-80 ch flat-type AWGs (i.e., three AWG chips, D, E and F) manufactured using a conventional photomask and a transmission spectrum of design values, and FIG. 6B is a graph representing the top portions of the transmission spectra illustrated in FIG. 6A;

FIG. 7A is a graph indicating results of calculating 11 patterns of transmission spectra by providing a phase distribution of a(m−M/2)²+b(m−M/2)+c (where a=−0.5π to 0.5π, b=c=0) to the m^{th} channel waveguide of an arrayed waveguide, and FIG. 7B is a graph representing the top portions of spectra illustrated in FIG. 7A;

FIG. 8A is a graph indicating results of calculating 11 patterns of transmission spectra by providing a phase distribution of a(m−M/2)³+b(m−M/2)²+c(m−M/2)+d (where a=−0.5π to 0.5π, b=c=d=0) to the m^{th} channel waveguide of the arrayed waveguide, and FIG. 8B is a graph representing the top portions of spectra illustrated in FIG. 8A;

FIG. 9A is a graph indicating transmission spectra of the arrayed waveguide grating according to a first example of the present invention, and FIG. 9B is a graph representing the top portions of the transmission spectra illustrated in FIG. 9A;

FIG. 10A is a graph indicating transmission spectra of the arrayed waveguide grating according to a second example of the present invention, and FIG. 10B is a graph representing the top portions of the transmission spectra illustrated in FIG. 10A;

FIG. 11 is a graph indicating transmission spectra of a 50 GHz-96 ch flat-type AWG before and after UV irradiation on its phase correcting portion and a transmission spectrum of design values;

FIG. 12 an explanatory view of a UV irradiation configuration according to a fifth embodiment and a sixth embodiment of the present invention;

FIG. 13A is a schematic diagram of a configuration of phase correcting portions of an AWG according to the sixth embodiment, and FIG. 13B is an enlarged view of the phase correction portions illustrated in FIG. 13A; and

FIG. 14 is a graph indicating transmission spectra of a 50 GHz-96 ch flat-type AWG before and after UV irradiation on its phase correcting portion and a transmission spectrum of design values.

### DETAILED DESCRIPTION OF THE PREFERRED EMBODIMENTS

Embodiments according to the present invention will be explained below with reference to the accompanying drawings. In explaining each embodiment, the same parts are referred to by the same reference numerals and redundant explanation will be omitted.

The inventors manufactured arrayed waveguide gratings (AWG chips A to F), analyzed transmission spectrum characteristics of the manufactured arrayed waveguide gratings in detail, and found that in most cases it was possible to explain a phase error generated in an arrayed waveguide with a quadratic-function phase distribution or a cubic-function phase distribution and that the phase error was caused by the photomask. Although not understood in detail yet, phase error distributions generated in arrayed waveguides are considered to be of a quadratic or cubic function attributed to forms or the like of the manufactured arrayed waveguide gratings.

Accordingly, the inventors found that by introducing a phase correcting portion for correcting a quadratic-function phase error or a cubic-function phase error to an arrayed waveguide of an arrayed waveguide grating, using a phase corrector provided in a photomask beforehand, AWG characteristics that cause no problem for practical use were obtained.

The present invention has been made in view of the above findings, and provides an AWG manufactured by introducing beforehand a phase distribution of, for example, a quadratic-function or a cubic-function for correcting a phase error in the arrayed waveguide as a waveguide parameter of the arrayed waveguide.

Further, according to an embodiment of the present invention, in an arrayed waveguide grating manufactured by incorporating a phase correcting portion as mentioned above, because only the phase correcting portion of the arrayed waveguide grating is subjected to UV irradiation, characteristics of the AWG are finely adjusted, a transmission spectrum close to design values is obtained, and the arrayed waveguide grating suitable for mass production is provided. This method is particularly effective for high-end arrayed waveguides like 50 GHz-96 ch arrayed waveguides, for example.

Furthermore, according to the present invention, because an arrayed waveguide grating includes a main phase correcting portion and a plurality of fine adjustment phase correcting portions, by subjecting one or more of the phase correcting portions to UV irradiation, further fine adjustment of AWG characteristics is enabled, a transmission spectrum close to design values is obtained, and the arrayed waveguide grating suitable for mass production is provided.

### First Embodiment

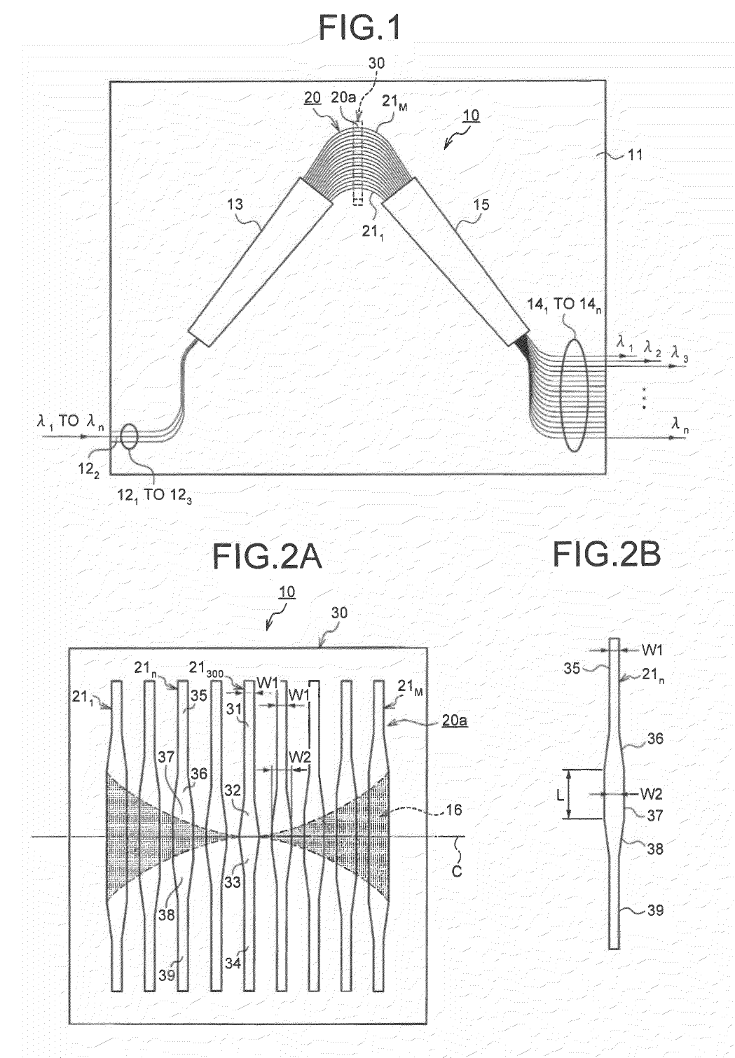

An arrayed waveguide grating (hereinafter, “AWG”) 10 according to a first embodiment of the present invention is a planar light wave circuit (PLC) in which an optical waveguide including a core and a cladding is formed on a quartz substrate 11 with a quarts PLC manufacturing technology using a semiconductor microprocessing technology, such as photolithography, as illustrated in FIG. 1.

The AWG 10 includes three input waveguides 12₁ to 12₃, an input slab waveguide 13 connected to the input waveguides 12₁ to 12₃, a plurality of (n) output waveguides 14₁ to 14ₙ, an output slab waveguide 15 connected to the output waveguides 14₁ to 14ₙ, and an arrayed waveguide 20 including M channel waveguides 21₁ to 21_{M} connected between the input slab waveguide 13 and the output slab waveguide 15. The number of input waveguides of the AWG 10 is not limited to three as long as there is at least one of them. A silicon substrate may be used instead of the quartz substrate 11.

The channel waveguides of the arrayed waveguide 20 are counted from the inner channel waveguide sequentially, like the first, the second, . . . , the m^{th}, . . . , and the M^{th}. Specifically, the channel waveguide 21₁ is the first channel waveguide and the channel waveguide 21_{M} is the M^{th} channel waveguide. In the first embodiment, as an example, the number M of channel waveguides of the arrayed waveguide 20 is 600 (M=600). FIG. 1 illustrates the channel waveguides in the arrayed waveguide 20 with a smaller number for simplification.

In the AWG 10, the length of each of the channel waveguides 21₁ to 21_{M} in the arrayed waveguide 20 increases by a constant pitch (an optical path length difference ΔL).

Specifically, if the length of the innermost channel waveguide 21₁ of the M channel waveguides 21₁ to 21_{M} is Lₒ, the length of the m^{th} channel waveguide 21ₘ is L₀+(m−1)ΔL.

The AWG 10 according to the first embodiment having the above-described configuration has the same configuration as that of a conventional AWG in which the arrayed waveguide includes M channel waveguides, the widths of the channel waveguides are equal, and the length of each of the channel waveguides increases by a constant optical path length difference ΔL, except for the following. In the conventional AWG, widths of the channel waveguides in the arrayed waveguide are all equal (hereinafter, “basic waveguide width W1”). To manufacture such conventional AWGs by using, for example, photolithography, a photomask to be used includes a waveguide pattern for forming a plurality of channel waveguides having the basic waveguide width W1 in an array waveguide forming area that is a part of a waveguide forming area. Such a photomask having a waveguide pattern for forming all of the channel waveguides of the arrayed waveguide with the same basic waveguide width W1 is hereinafter referred to as a “conventional photomask”.

In the AWG 10 according to the first embodiment illustrated in FIG. 1, the arrayed waveguide 20 is provided with a phase correcting portion 30 that provides a predetermined phase to at least a part of the M channel waveguides 21₁ to 21_{M} by changing the shape of at least a part of the channel waveguides.

In the first embodiment, for correcting a phase error distribution of a quadratic function generated in the arrayed waveguide 20, the phase correcting portion 30 is formed to provide a phase having a magnitude expressed by a(m−M/2)²+b(m−M/2)+c to the m^{th} (1≦m≦M) channel waveguide of the M channel waveguides 21₁ to 21_{M}, where a, b and c are each a constant of a value within a range of −2π to 2π (radians).

As illustrated in FIGS. 1 and 2A, the phase correcting portion 30 is provided in a linear waveguide portion 20a of the arrayed waveguide 20. FIG. 2A represents an enlarged view of the structure of the phase correcting portion 30 illustrated in FIG. 1 and schematically illustrates a phase distribution 16 of the quadratic function that the phase correcting portion 30 provides to each of the channel waveguides 21₁ to 21_{M} of the arrayed waveguide 20. FIG. 2A also illustrates the channel waveguides 21₁ to 21_{M} of the arrayed waveguide 20 with a number smaller than the actual number M for simplification.

The phase correcting portion 30 is configured to provide a phase having the magnitude expressed by a(m−M/2)²+b(m−M/2)+c to the m^{th} channel waveguide of the M channel waveguides 21₁ to 21_{M}, so as to correct the phase error in the m^{th} channel waveguide. For example, if a phase correcting portion is required in the m^{th} channel waveguide, in a region corresponding to the phase correcting portion of the m^{th} channel waveguide, a wide waveguide having a length corresponding to the m^{th} channel waveguide and having a width W2 larger than the basic waveguide width W1 is incorporated. The phase correcting portion 30 is configured such that the phase correcting portion 30 includes the wide waveguide in each of a part or all of the M channel waveguides and that a length of the wide waveguide is different for each channel waveguide.

Specifically, as illustrated in FIG. 2A, in the phase correcting portion 30, the 300^{th} (m=300) channel waveguide 21₃₀₀ has a configuration in which a linear waveguide 31 having the basic waveguide width W1, a tapered waveguide 32, a tapered waveguide 33, and a linear waveguide 34 having the basic waveguide width W1 are connected one after another. In other words, the channel waveguide 21₃₀₀ is not provided with the wide waveguide having the width W2 larger than the basic waveguide width W1.

In any of the first embodiment and embodiments described below, a length, an angle, and a form of a taper in a tapered waveguide is determined as appropriate to prevent occurrence of a higher-order mode. The lengths, angles, and forms of the tapers may be the same among tapered waveguides of the channel waveguides.

In the phase correcting portion 30, as illustrated in FIGS. 2A and 2B, each channel waveguide 21, other than the channel waveguide 21₃₀₀ (1≦n≦M, n≠300) of the M channel waveguides 21₁ to 21_{M} has a configuration in which a linear waveguide 35 having the basic waveguide width W1, a tapered waveguide 36, a wide waveguide 37 having the width W2, a tapered waveguide 38, and a linear waveguide 39 having the basic waveguide width W1 are connected one after another.

In the phase correcting portion 30, the length L of the wide waveguide 37 of each channel waveguide 21ₙ is different for each channel waveguide. In the first embodiment, to provide a phase having the magnitude expressed by a(m−M/2)²+b(m−M/2)+c to the m^{th} channel waveguide, the length L is set as follows.

The length L of the wide waveguide 37 of the first channel waveguide 21₁ and the length L of the wide waveguide 37 of the M^{th} (600^{th}) channel waveguide 21_{M} are the longest and the length L becomes gradually shorter from the first channel waveguide 21₁ toward the channel waveguide 21₂₉₉ and becomes shorter gradually from the channel waveguide 21_{M} toward the channel waveguide 21₃₀₁.

In the phase correcting portion 30, the shapes of the tapered waveguides 32, 33, 36 and 38 are uniform. Because a pair of tapered waveguides shaped identically is provided in each of the M channel waveguides 21₁ to 21_{M}, no phase error is generated among the channel waveguides 21₁ to 21_{M}.

A phase φ that the phase correcting portion 30 provides to each of the channel waveguides 21₁ to 21_{M} is represented by the following equation (equation (1)).

φ=(2π/λ)(n_{corr}−n_{org})·L (1)

In this equation (1), n_{org} is the refractive index of a linear waveguide having the basic waveguide width W1 in each channel waveguide, n_{corr} is the refractive index of a wide waveguide in each channel waveguide, and L is the length of a wide waveguide in each channel waveguide

In the phase correcting portion 30, the linear waveguide portion 20a of the arrayed waveguide 20, i.e., the linear waveguide of each of the channel waveguides 21₁ to 21_{M} (excluding the channel waveguide 21₃₀₀) is provided with the wide waveguide 37 having the width W2. Consequently, the effective refractive index of each channel waveguide is increased and a phase larger than a phase that would be provided if the wide waveguide were not included is provided to each channel waveguide. In addition, in the phase correcting portion 30, because the length L of the wide waveguide 37 of each of the channel waveguides 21₁ to 21_{M} (excluding the channel waveguide 21₃₀₀) is set such that the phase having the magnitude expressed by a(m−M/2)²+b(m−M/2)+c is provided to the m^{th} channel waveguide, the magnitudes of phases to be provided to the channel waveguides 21₁ to 21_{M} (excluding the channel waveguide 21₃₀₀) become different.

By providing the phase correcting portion 30 configured as above in the linear waveguide portion of the arrayed waveguide 20, it is possible to provide a phase having the magnitude expressed by a(m−M/2)²+b (m−M/2)+c to the m^{th} channel waveguide of the channel waveguides 21₁ to 21_{M}.

Reference numeral 16 in FIG. 2A schematically represents a phase distribution of a quadratic-function that the phase correcting portion 30 provides to the arrayed waveguide 20. In the phase distribution 16, an up-and-down direction in FIG. 2A represents the magnitude of the phase in FIG. 2A.

In the first embodiment, the center of the wide waveguide 37 of each of the channel waveguides 21₁ to 21_{M} (excluding the channel waveguide 21₃₀₀) and a connection point between the tapered waveguide 32 and the tapered waveguide 33 of the channel waveguide 21₃₀₀ each coincide with the center C of the arrayed waveguide 20. Therefore, the phase correcting portion 30 provides a phase to each of the channel waveguides 21₁ to 21_{M} symmetrically about the center of the AWG 10, i.e., the center C of the arrayed waveguide 20.

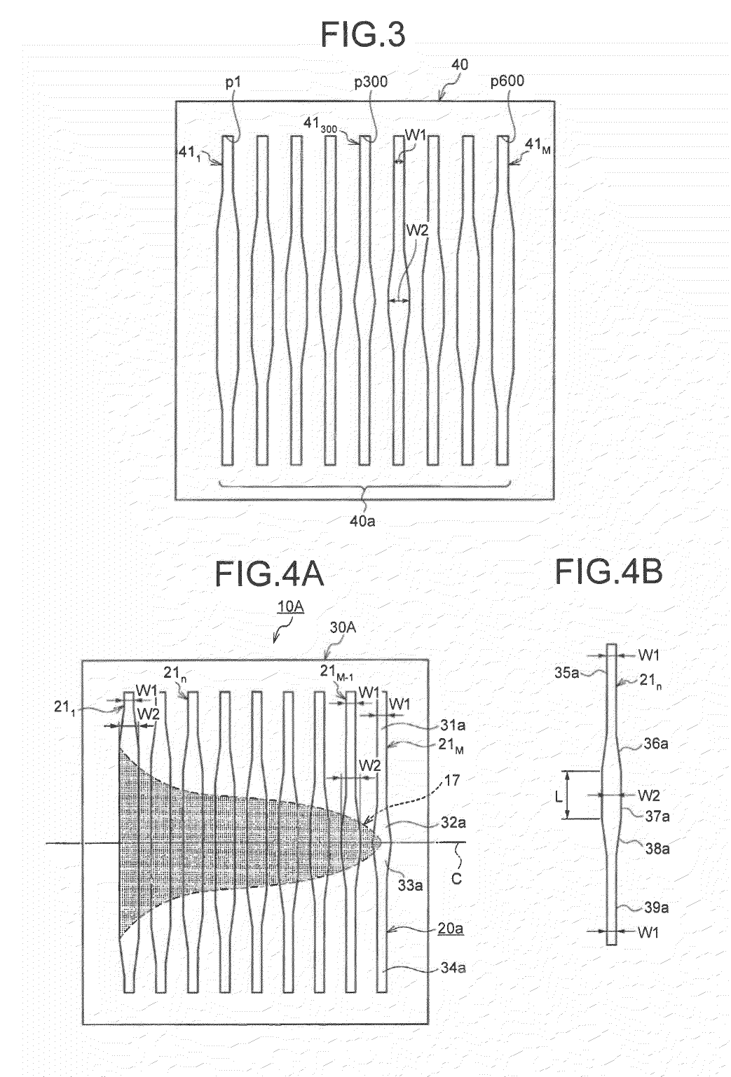

When the AWG 10 provided with the phase correcting portion 30 in the linear waveguide portion of the arrayed waveguide 20 is manufactured using photolithography, a photomask 40 as illustrated in FIG. 3 is used, which is structured differently from the above conventional photomask. FIG. 3 illustrates only the phase corrector of the waveguide pattern formed on the photomask 40 for forming each waveguide of the AWG 10. This phase corrector is for forming the phase correcting portion 30 in the arrayed waveguide forming area for forming each channel waveguide of the arrayed waveguide 20.

The photomask 40 includes a phase corrector 40a illustrated in FIG. 3. Waveguide patterns 41₁ to 41_{M} as illustrated in FIG. 3 are formed in the phase corrector 40a. These waveguide patterns 41₁ to 41_{M} are for respectively forming the M channel waveguides 21₁ to 21_{M} of the phase correcting portion 30 illustrated in FIG. 2A. Hereinafter, the photomask 40 is referred to as “photomask of the present invention”.

In the AWG 10 according to the first embodiment configured as above, when multiplexed lights of a plurality of lights having different wavelengths (λ₁ to λₙ) are input through one of the input waveguides 12₁ to 12₃, for example, through the input waveguide 12₂, the lights (of wavelengths λ₁ to λₙ) diverge in the input slab waveguide 13 by diffraction and then are input to the arrayed waveguide 20. The arrayed waveguide 20 includes the M channel waveguides 21₁ to 21_{M} and adjacent channel waveguides are arrayed with the constant optical path length difference ΔL between them. Therefore, at an output end of the arrayed waveguide 20, the lights that have passed through the respective channel waveguides 21₁ to 21_{M} have a phase difference. The lights that have passed through the arrayed waveguide 20 then propagate to the output slab waveguide 15 and diverge by diffraction, but the lights that have passed through the respective channel waveguides 21₁ to 21_{M} interfere with each other. Accordingly these lights intensify each other only in a direction in which their wave fronts match each other and are condensed.

The condensing direction differs depending on the wavelength. Therefore, by arranging the output waveguides 14₁ to 14ₙ at respective condensing positions that differ according to the wavelengths in an output portion of the output slab waveguide 15, it is possible to output lights of different wavelengths λ₁ to λₙ from the respective output waveguides 14₁ to 14ₙ. In this case, the AWG 10 functions as a demultiplexer. In the case where the AWG is used as a multiplexer, when lights of wavelengths λ₁ to λₙ are input through the respective output waveguides 14₁ to 14ₙ, multiplexed lights of different wavelengths (λ₁ to λₙ) are output from one of the input waveguides 12₁ to 12₃, for example, the input waveguide 12₂.

### Second Embodiment

An arrayed waveguide grating (AWG) 10A according to a second embodiment of the present invention will be explained below with reference to FIGS. 4A and 4B.

In the AWG 10A according to the second embodiment, to correct a phase error distribution of a cubic function generated in an arrayed waveguide, a phase correcting portion 30A is formed such that a phase having a magnitude expressed by a(m−M/2)³+b(m−M/2)²+c(m−M/2)+d is provided to the m^{th} (1≦m≦M) channel waveguide of the M channel waveguides 21₁ to 21_{M}, where a, b and c are each a constant of a value within a range of −2π to 2π (radians). The configuration of the AWG 10A except for the phase correcting portion 30A is similar to that of the AWG 10 according to the first embodiment.

As illustrated in FIG. 4A, the phase correcting portion 30A is provided in the linear waveguide portion 20a (see FIG. 1) in the arrayed waveguide 20 like the phase correcting portion 30 according to the first embodiment. Similarly to FIG. 2A, FIG. 4A represents an enlarged view of a structure of the phase correcting portion 30 and schematically illustrates the phase distribution of the cubic function that the phase correcting portion 30A provides to each of the channel waveguides 21₁ to 21_{M} in the arrayed waveguide 20. FIG. 4A also represents the channel waveguides 21₁ to 21_{M} in the arrayed waveguide 20 with a number smaller than the actual number M (M=600) for simplification.

The phase correcting portion 30A is configured to provide the phase having the magnitude expressed by a(m−M/2)³+b (m−M/2)²+c(m−M/2)+d to the m^{th} channel waveguide of the M channel waveguides 21₁ to 21_{M}, to thereby correct the phase error in the m^{th} channel waveguide. For example, if a phase correcting portion is required in the m^{th} channel waveguide, in a region corresponding to the phase correcting portion of the m^{th} channel waveguide, a wide waveguide having a length corresponding to the m^{th} channel waveguide and having the width W2 larger than the basic waveguide width W1 is incorporated. The phase correcting portion 30A has a configuration in which the phase correcting portion 30A includes the wide waveguide in each of a part or all of the M channel waveguides and the length of the wide waveguide is different for each channel waveguide.

Specifically, as illustrated in FIG. 4A, in the phase correcting portion 30A, the 600^{th} (M=600) channel waveguide 21_{M} has a configuration in which a linear waveguide 31a having the basic waveguide width W1, a tapered waveguide 32a, a tapered waveguide 33a, and a linear waveguide 34a having the basic waveguide width W1 are connected one after another. In other words, the channel waveguide 21_{M} is not provided with the wide waveguide having the width W2 larger than the basic waveguide width W1.

In the phase correcting portion 30A, each channel waveguide 21ₙ other than the channel waveguide 21_{M} (1≦n≦M−1) of the M channel waveguides 21₁ to 21_{M} has a configuration, as illustrated in FIG. 4B, in which a linear waveguide 35a having the basic waveguide width W1, a tapered waveguide 36a, a wide waveguide 37a having the width W2, a tapered waveguide 38a, and a linear waveguide 39a having the basic waveguide width W1 are connected one after another.

In the phase correcting portion 30A, the length L of the wide waveguide 37a of each channel waveguide 21ₙ is different for each channel waveguide, such that the phase provided to each channel waveguide 21ₙ is different for each channel waveguide. In the first embodiment, to provide the phase having the magnitude expressed by a(m−M/2)³+b(m−M/2)²+c(m−M/2)+d to the m^{th} channel waveguide, the length L is set as follows.

The length L of the wide waveguide 37a of the first channel waveguide 21₁ is the longest and the length becomes gradually shorter from the first channel waveguide 21₁ to the channel waveguide 21_{M-1}. Further, in the phase correcting portion 30A, the shapes of the tapered waveguides 32a, 33a, 36a and 38a are uniform.

By providing the phase correcting portion 30A configured as above in the linear waveguide portion 20a of the arrayed waveguide 20, it is possible to provide a phase having a magnitude expressed by a(m−M/2)³+b(m−M/2)²+c(m−M/2)+d to the m^{th} channel waveguide of the channel waveguides 21₁ to 21_{M}.

In FIG. 4A, the portion denoted by reference numeral 17 schematically represents a cubic-function phase distribution that the phase correcting portion 30A provides to the arrayed waveguide 20.

In the second embodiment, the center of the wide waveguide 37a of each of the channel waveguides 21₁ to 21_{M-1} and a connection point between the tapered waveguide 32a and the tapered waveguide 33a of the channel waveguide 21_{M} each coincide with the center C of the arrayed waveguide 20. Therefore, the phase correcting portion 30A provides a phase to the channel waveguides 21₁ to 21_{M} symmetrically about the center of the AWG 10A, i.e., the center C of the arrayed waveguide 20.

When the AWG 10A in which the phase correcting portion 30A is provided in the linear waveguide portion 20a of the arrayed waveguide 20 is manufactured using photolithography, the photomask 40 of the present invention (not illustrated) is used, which includes a phase corrector according to the phase correcting portion 30A illustrated in FIG. 4A, similarly to the phase corrector 40a of the photomask of the present invention 40 illustrated in FIG. 3. A waveguide pattern for forming the M channel waveguides 21₁ to 21_{M} in the phase correcting portion 30A illustrated in FIG. 4A is formed in the phase corrector of this photomask.

### Third Embodiment

Method of Manufacturing AWG 10

A method of manufacturing the AWG 10 or the AWG 10A having the above configurations will be explained below.

Step (1) First, “conventional AWGs” are manufactured by, for example, photolithography by using the “conventional photomask”.

In other words, the conventional AWGs each including an arrayed waveguide formed of M channel waveguides of equal widths are manufactured.

For example, 50 GHz-80 ch flat-type AWGs are manufactured.

Step (2) Subsequently, the transmission spectra of the conventional AWGs that are manufactured at step (1) are measured to obtain their actual values.

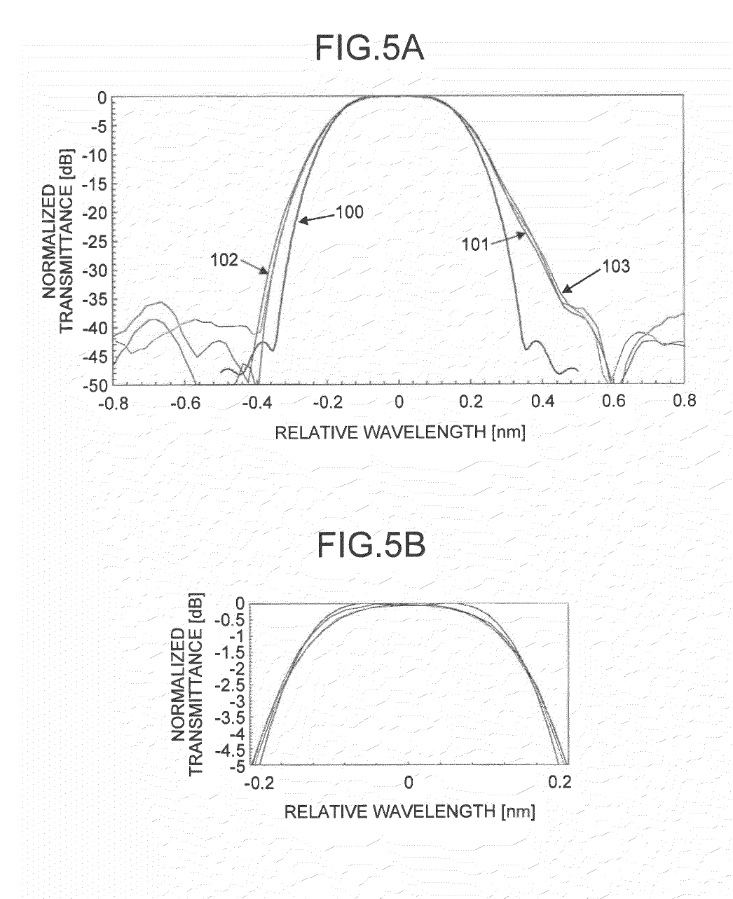

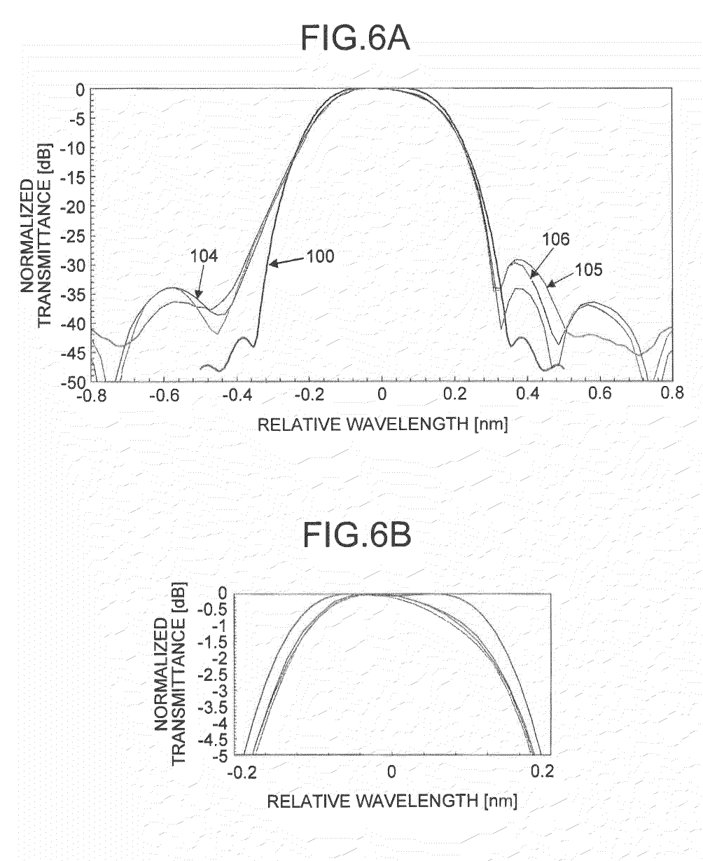

FIGS. 5A and 5B and FIGS. 6A and 6B represent the results of manufacturing the 50 GHz-80 ch flat-type AWGs. In FIG. 5A, a curve 100 denotes a transmission spectrum of design values of the flat-type AWGs, and curves 101, 102, and 103 denote actual values in transmission spectra of the manufactured conventional AWGs (AWG chips) A, B, and C. In FIG. 6A, the curve 100 denotes the transmission spectrum of the design values of the flat-type AWGs and curves 104, 105, and 106 denote measured transmission spectra of the manufactured conventional AWGs D, E, and F.

From FIG. 5A, it is understood that the shapes of the transmission spectra of the AWG chips A, B, and C approximately coincide with each other. Further, from FIG. 6A, it is understood that the shapes of the transmission spectra of the AWG chips A, B, and C approximately coincide with each other. From these, it is understood that the AWG chips A, B, C, D, E, and F, which have transmission spectrum shapes that approximately match each other are manufactured.

Furthermore, it is understood, by carefully observing FIG. 5A, that the spectra of the AWG chips A, B, and C, which are represented by the curves 101, 102, and 103, are more spread than the transmission spectrum of the design-values, and that the top of each of the spectra is rounded (see FIG. 5B). In contrast, from FIG. 6A, it is understood that the top portion of each of the transmission spectra of the AWG chips D, E, and F, which are represented by the curved lines 104, 105, and 106, is sloped (see FIG. 6B).

The inventors manufactured various AWGs, and found that in many cases, the transmission spectrum characteristics demonstrated by the manufactured AWGs corresponded to FIG. 5A or FIG. 6A.

In all of the transmission spectrum characteristics represented in FIGS. 5A and 6A, phase variation occurs in the arrayed waveguides, and the AWG characteristics are degraded. In other words, in the AWG chips A, B, and C represented by the curves 101, 102, and 103 in FIG. 5A, manufacturing errors in the photomask itself result in phase errors in the arrayed waveguides and degradation in the AWG characteristics. Similarly, in the AWG chips D, E, and F represented by the curves 104, 105, and 106 in FIG. 6A, manufacturing errors in the photomask itself result in phase errors in the arrayed waveguides and degradation in the AWG characteristics.

Step (3) Phase error distributions that occur in the arrayed waveguides 20 due to manufacturing errors in the photomask itself is calculated based on the degradation in the transmission spectrum characteristics of the conventional AWGs (the degradation in the characteristics illustrated in FIGS. 5A and 6A), which is obtained at step (2).

For example, fitting with the actual values is performed, limiting to a quadratic-function phase error or a cubic-function phase error, to obtain the phase error distributions that occur in the arrayed waveguides 20.

Specifically, a phase of a(m−M/2)²+b(m−M/2)+c is provided to the m^{th} channel waveguide, transmittance is calculated, and a phase error distribution of a quadratic-function that fits the transmission spectrum of the design values is obtained. Alternatively, a phase of a(m−M/2)³+b(m−M/2)²+c(m−M/2)+d is provided to the m^{th} channel waveguide, transmittance is calculated, and a phase error distribution of a cubic-function that fits the transmission spectrum of the design values is obtained. The “phase error distribution” used herein is a distribution of phase errors that occur in the channel waveguides of the arrayed waveguides.

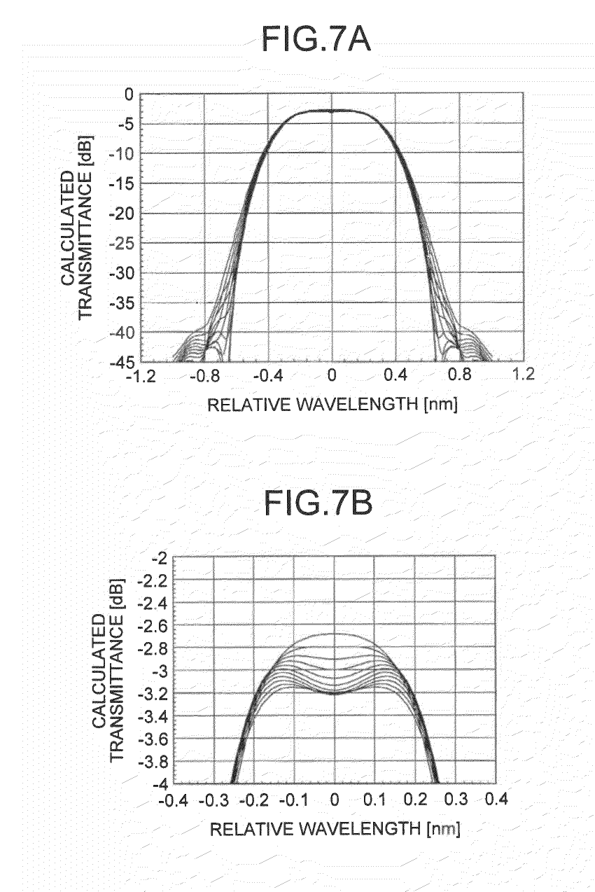

It was found, as illustrated in FIGS. 7A and 7B, that when the phase distribution of the quadratic-function was provided to the AWG, the transmission spectra were spread and the top portions of the spectra were rounded. FIG. 7A represents calculated values of 11 patterns of transmission spectra that are obtained when b=c=0 and the value of “a” is changed within the range of −0.5π to 0.5π by 0.1π.

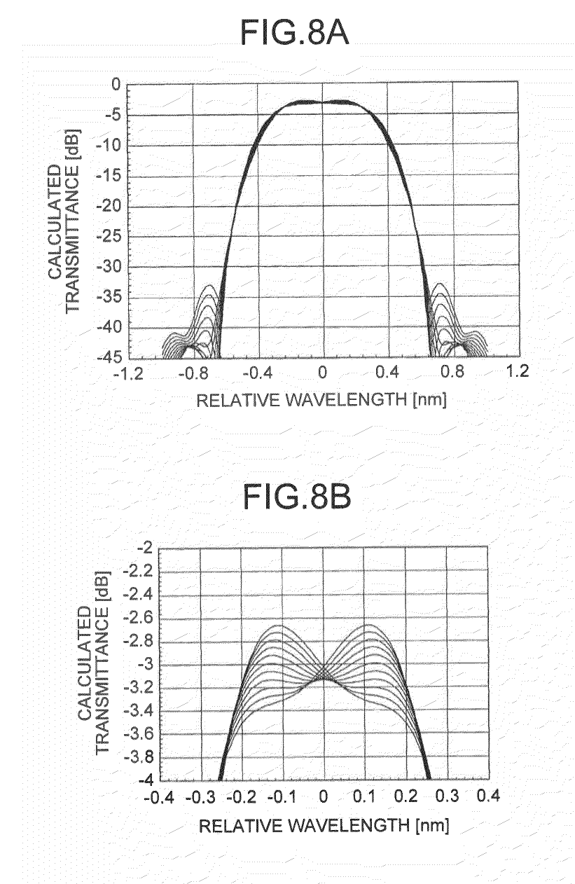

As illustrated in FIGS. 8A and 8B, it was found that when the phase distribution of the cubic-function phase distribution was provided to the AWG, the top portions of the spectra were sloped. FIG. 8A represents calculated values of 11 patterns of transmission spectra that are obtained when b=c=d=0 and the value of “a” is varied within the range of −0.5π to 0.5π by 0.1π.

At step (3), when the transmission spectrum characteristics of the manufactured AWGs are measured and the transmission spectrum characteristics (actual values) illustrated in FIG. 5A are obtained, the phase error distribution of the quadratic-function is provided to the design values to calculate a transmission spectrum. When the transmission spectrum characteristics (actual values) depicted in FIG. 6A are obtained, the phase error distribution of the cubic-function is provided to the design values to calculate a transmission spectrum. Thereafter, a phase error distribution is extracted for which the calculated transmission spectrum fits, by the least squares method, the transmission spectrum of the design values, which is represented by the curve 100 in FIG. 5A or FIG. 6A.

As described above, at step (3), calculation is performed premised on the phase correcting portion that provides to the arrayed waveguide 20 the phase error of the quadratic-function or the cubic-function as input information, to find the form closest to the actual values.

For example, if there is degradation in the characteristics of the AWG as illustrated in FIGS. 5A and 5B, variation in the phase is occurring in the arrayed waveguide 20. In this case, at step (3), by reverse computation by inserting the phase distribution of the quadratic-function phase distribution to the design values of the conventional AWGs, for which the characteristics illustrated in FIG. 5A were obtained, the transmission spectrum characteristics that are approximately close to the design values are obtained.

Conversely, because phase distributions deviated from the design values (phase error distributions) are generated in the actually manufactured conventional AWGs with degradation in their characteristics as illustrated in FIG. 5A, by incorporating phase correctors for correcting these phase error distributions into the photomask from the design stage, the finally manufactured AWGs 10 will have transmission spectrum characteristics approximately close to the design values.

In contrast, if there is degradation in the characteristics of the AWG as illustrated in FIGS. 6A and 6B, variation in the phase is occurring in the arrayed waveguide 20. In this case, at step (3), by reverse computation inserting the phase distribution of the cubic-function to the design values of the conventional AWGs, for which the characteristics illustrated in FIG. 6A were obtained, the actual values of the transmission spectrum characteristics that are approximately close to the design values are obtained.

Conversely, because the phase distributions deviated from the design values (phase error distributions) are generated in the actually manufactured conventional AWGs having the degradation in their characteristics as illustrated in FIG. 6A, by incorporating the phase correctors for correcting the phase error distributions into the photomask from the design stage, the finally manufactured AWGs 10 will have transmission spectrum characteristics approximately close to the design values.

Step (4) A form of the phase correcting portion (the phase correcting portion 30 in FIG. 2A or the phase correcting portion 30A in FIG. 4A), which will provide to each channel waveguide in the arrayed waveguides a phase for compensating (eliminating) the phase error distributions calculated at step (3), is determined. At this step, for example, the width W2 and the length L of the wide waveguide 37 in each of the channel waveguides 21₁ to 21ₘ are determined. For example, in equation (1), n_{corr} is dependent on the width W2, and if the width W2 is fixed, n_{corr} becomes a constant, and thus the phase φ is adjustable by the length L of the wide waveguide. Accordingly, since those other than L are constants in equation (1), L corresponding to the phase φ to be provided to each channel waveguide obtained at step (3) is obtainable. Although W2 has been explained to be fixed, the value of the phase φ to be provided is adjustable when L is fixed and W2 is changed

Step (5) A photomask (the “photomask of the present invention”) is then manufactured, which has an arrayed waveguide forming area for forming an arrayed waveguide, to which a phase correcting portion of the form determined at step (4) is introduced.

In the first embodiment, the photomask 40 of the present invention (FIG. 3) is newly manufactured. In this photomask 40, a phase corrector (phase correcting portion 30), which is configured to provide a phase that corrects (cancels) the phase error distribution calculated at step (3), is arranged in the linear waveguide portion of the arrayed waveguide in the conventional photomask that is used to manufacture the AWGs demonstrating the transmission spectrum characteristics 101, 102, and 103 illustrated in FIG. 5.

That is, in the process of manufacturing the conventional photomask and the manufacturing environment (such as the manufacturing apparatus), which are used at step (1), a photomask provided with a phase corrector is manufactured, such that a region corresponding to a part of a linear waveguide of an arrayed waveguide of the conventional photomask is changed to the phase correcting portion 30 (or the phase correcting portion 30A) obtained at step (4). Consequently, the photomask of the present invention is obtainable, in which the phase corrector having the configuration obtained through steps (2) to (4) has been incorporated into a part of the arrayed waveguide of the conventional photomask used in step (1).

Conventionally, when manufacturing an AWG having an arrayed waveguide of a certain form, specific errors are generated in the AWG manufacturing process, the manufacturing environment, and the form of the AWG, and these errors influence at least phase errors of the manufactured AWG. As a result, the errors are distributed in a form of a quadratic or cubic function. Therefore, as long as a photomask for AWGs is manufactured using the same manufacturing process and the same manufacturing environment with respect to an AWG of the same form, phase errors of the same trend, i.e., of the quadratic or cubic function form are generated.

In contrast, according to the present embodiment, as described above, an AWG is manufactured once using the conventional photomask, phase errors are obtained, which reflect specific errors in the manufacturing process of the photomask, the manufacturing environment, and the form of the AWG, a configuration of a phase correcting portion configured to correct the phase errors is determined, and a photomask, in which a phase corrector has been incorporated into a part of an arrayed waveguide of a photomask for the same AWG, is manufactured using the same manufacturing process and the manufacturing environment as the conventional photomask. Therefore, when the AWG is formed by the photomask, the AWG in which the phase errors have been compensated and corrected is able to be generated.

In the present embodiment, the example of newly manufacturing a photomask, in which the phase corrector determined at step (4) based on the AWGs formed using the photomask used at step (1) has been incorporated, has been explained, but what is important in the present embodiment is that the structure of the phase correcting portion determined at step (4) is incorporated into the photomask of the form used at step (1). Therefore, for example, a portion corresponding to a part of the linear waveguide of the arrayed waveguide of the photomask used at step (1) may be eliminated, and the phase correcting portion having the structure determined at step (4) may be arranged there to manufacture the photomask 40 of the present invention.

Similarly, in the second embodiment, a photomask of the present invention (not illustrated) is newly manufactured. In this photomask of the present invention, the phase corrector (phase correcting portion 30A), which provides the phase that corrects (cancels) the phase error distribution calculated at step (3), is arranged in the linear waveguide portion of the arrayed waveguide of the conventional photomask that is used to manufacture the AWGs demonstrating the transmission spectrum characteristics 104, 105, and 106 illustrated in FIG. 6. Alternatively, a portion corresponding to a part of the linear waveguide of the arrayed waveguide of the photomask used at step (1) may be eliminated, and the phase correcting portion having the structure determined at step (4) may be arranged there, to manufacture the photomask 40 of the present invention. As described above, the waveguide parameters, which are the phase corrector and which correct the phase error distribution are incorporated in the photomask of the present invention in advance.

Step (6) Next, the AWG (50 GHz-80 ch flat-type AWG) 10 according to the first embodiment or the AWG (50 GHz-80 ch flat-type AWG) 10A according to the second embodiment is manufactured using the photomask of the present invention manufactured at step (5).

### First Example

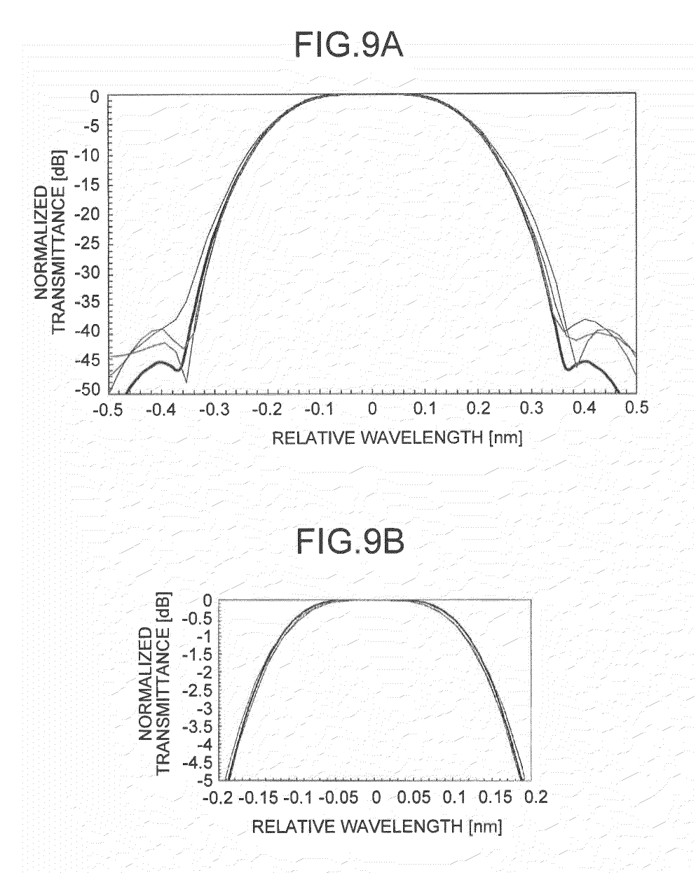

The 50 GHz-80 ch flat-type AWGs 10 (see FIG. 1) including the phase correcting portion 30 as illustrated in FIG. 2A were manufactured by a normal quartz PLC technology. Specifically, in the photomask 40 of the present invention illustrated in FIG. 3, the wide waveguides 37 each having the width W2 were formed and the length L of each of the wide waveguides 37 was set to a predetermined value, such that a phase of 0.7π(m−M/2)² was provided to the m^{th} channel waveguide of the channel waveguides 21₁ to 21_{M}. The transmission spectrum characteristics of the manufactured AWGs 10 are depicted in FIGS. 9A and 9B. It is understood from FIGS. 9A and 9B that transmission spectra approximate to the design values are obtained in the manufactured AWGs 10 and the method according to the present invention is very effective.

### Second Example

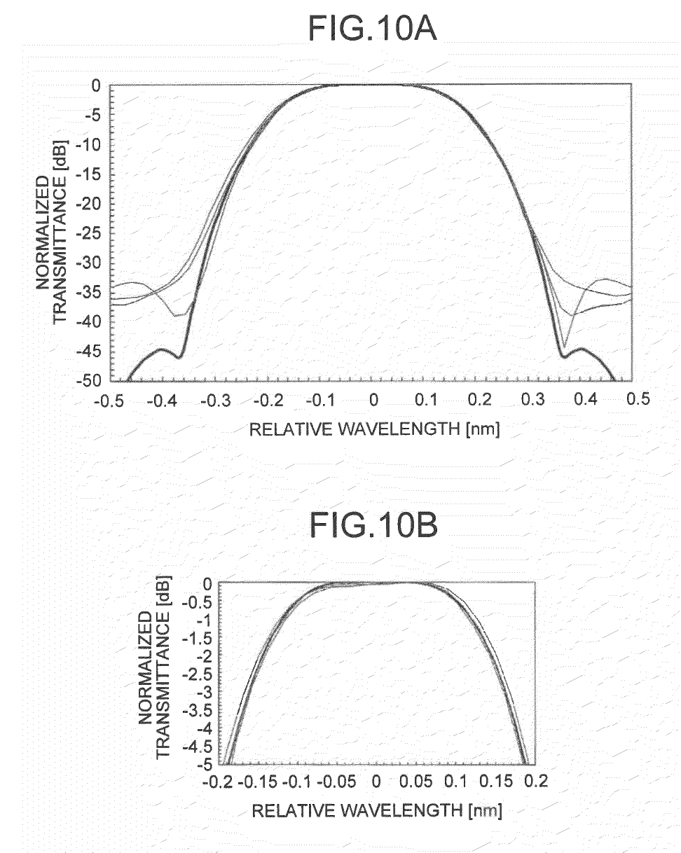

Using the normal quartz PLC technology, 50 GHz-80 ch flat-type AWGs 10A each including the phase correcting portion 30A as illustrated in FIG. 4A were manufactured. Specifically, in the above-described photomask of the present invention, the wide waveguides 37a (see FIG. 4B) each having the width W2 were formed in the photomask of the present invention and the length L of each of the wide waveguides 37a was set to a predetermined value, such that a phase of 0.3π(m−M/2)³ was provided to the m^{th} (1≦m≦M) channel waveguide of the M channel waveguides 21₁ to 21_{M}. The transmission spectrum characteristics of the manufactured AWGs 10A are illustrated in FIGS. 10A and 10B. It is understood from FIGS. 10A and 10B that transmission spectra approximate to the design values are obtained in the manufactured AWGs 10A and the method according to the present invention is very effective.

The first embodiment works and provides effects as described below.

(1) The phase correcting portion 30 provides a phase of a(m−M/2)² b (m−M/2)+c to the m^{th} channel waveguide, so that the phase in each of the channel waveguides 21₁ to 21_{M} of the arrayed waveguide 20 is changed to cancel the phase errors in the arrayed waveguide 20 and a transmission spectrum close to the design values is obtained. In other words, by incorporating in advance the form that corrects the phase error generated in the conventional photomask in the phase corrector provided in the photomask of the present invention 40 and manufacturing an AWG using the photomask 40, it is possible to obtain transmission spectrum characteristics close to the design characteristics and realize the AWG 10 suitable for mass production.

(2) Because the phase correcting portion 30 illustrated in FIG. 2A is provided in the linear waveguide portion 20a of the arrayed waveguide 20, designing of the photomask 40 having the waveguide pattern for forming the phase correcting portion 30 and designing of the AWG 10 itself become easy.

(3) Because the phase correcting portion 30 provides a phase to each of the channel waveguides 21₁ to 21_{M} symmetrically about the center C of the arrayed waveguide 20, it is possible to change the phase in each of the channel waveguides 21₁ to 21_{M} symmetrically equally about the center C of the arrayed waveguide 20 and to obtain a transmission spectrum close to the design values.

(4) Because the phase correcting portion 30 is provided only in a narrow partial area of the arrayed waveguide 20, i.e., in the linear waveguide portion 20a, it is possible to ignore the influence of the manufacturing errors in the photomask 40 on the phase correcting portion 30 and to obtain a transmission spectrum close to the design values.

The second embodiment works and provides effects described below.

(1) The phase correcting portion 30A provides a phase of a(m−M/2)³+b(m−M/2)²+c(m−M/2)+d to the m^{th} channel waveguide, so that the phase in each of the channel waveguides 21₁ to 21_{M} in the arrayed waveguide 20 is changed to cancel the phase errors in the arrayed waveguide 20 and a transmission spectrum close to the design values is obtained. In other words, by incorporating in advance the form that corrects the phase errors generated in the conventional photomask into the phase corrector provided in the photomask of the present invention and manufacturing an AWG using the photomask, it is possible to obtain transmission spectrum characteristics close to the design characteristics and to realize the AWG 10A suitable for mass production.

(2) Because the phase correcting portion 30A illustrated in FIG. 4A is provided in the linear waveguide portion 20a of the arrayed waveguide 20, designing of the photomask having the waveguide pattern for forming the phase correcting portion 30A and designing of the AWG 10A itself become easy.

(3) Because the phase correcting portion 30A provides a phase to each of the channel waveguides 21₁ to 21_{M} symmetrically about the center C of the arrayed waveguide 20, it is possible to change the phase in each of the channel waveguides 21₁ to 21_{M} symmetrically equally about the center C of the arrayed waveguide 20 and to obtain a transmission spectrum close to the design values.

(4) Because the phase correcting portion 30A is provided only in a narrow partial area of the arrayed waveguide 20, i.e., in the linear waveguide portion 20a, it is possible to ignore the influence of the manufacturing errors in the photomask itself on the phase correcting portion 30 and to obtain a transmission spectrum close to the design values.

The present invention may be modified and embodied as described below.

In each of the embodiments, examples in which 50 GHz-80 ch flat-type AWGs are manufactured were explained, but the present invention is also applicable to a flat-type AWG with a different frequency interval and a different number of channels. For example, the present invention is applicable to 100 GHz-40 ch flat-type AWGs.

The present invention is not limited to flat-type AWGs and is applicable to Gaussian-type AWGs having transmission spectra of Gaussian function forms. Specifically, similarly to the first embodiment, the phase correcting portion is formed such that a phase of a(m−M/2)²+b(m−M/2)+c is applied to the m^{th} (1≦m≦M) channel waveguide of the M channel waveguides 21₁ to 21_{M}.

In each of the embodiments, the phase correcting portion has a configuration in which the phase correcting portion includes the wide waveguide having the width W2 larger than the basic waveguide width W1 in each of a part or all of the M channel waveguides and the length of the wide waveguide is different for each channel waveguide. However, the present invention is not limited to this. The present invention is applicable to an AWG including a phase correcting portion having a configuration in which only the length of each channel waveguide is changed in a part or all of the M channel waveguides, such that the optical path length of each channel waveguide is changed to correct the phase error distribution of the quadratic or cubic function.

Examples of a method of changing only the length of each channel waveguide include the following two examples.

(1) Only the lengths of the M channel waveguides 21₁ to 21_{M} are changed such that a phase of a(m−M/2)²+b(m−M/2)+c is provided to the m^{th} channel waveguide 21ₘ. In this case, the length of the m^{th} channel waveguide 21ₘ is represented by the following equation.

L₀+(m−1)ΔL+(λ/2π)[a(m−M/2)²+b(m−M/2)+c]

In this equation, Lₒ is the length of the innermost channel waveguide 21₁ of the M channel waveguides 21₁ to 21_{M}.

(2) Only the lengths of the M channel waveguides 21₁ to 21_{M} are changed such that a phase of a(m−M/2)³+b(m−M/2)²+c(m−M/2)+d is provided to the m^{th} channel waveguide 21ₘ. In this case, the length of the m^{th} channel waveguide 21ₘ is represented by the following equation.

L₀+(m−1)ΔL+(λ/2π)[a(m−M/2)³+b(m−M/2)²+c(m−M/2)+d]

Here, L₀ is the length of the innermost channel waveguide 211 of the M channel waveguides 21₁ to 21_{M}.

### Fourth Embodiment

A fourth embodiment of the present invention involves steps, which are substantially the same as those of the third embodiment, but at step (3), instead of finding the phase error distribution generated in the arrayed waveguide by performing the fitting with the actual values while limiting the phase error distribution generated in the arrayed waveguide to the phase error of the quadratic or cubic function, the fourth embodiment is characterized in that a phase error distribution generated in an arrayed waveguide is found by measuring phase errors from design values actually generated in each channel waveguide.

Such a phase error distribution found by the actual measurement is used to determine a form of the phase correcting portion at step (4). The other steps are the same as those of the third embodiment. In the present embodiment, the measurement of the phase error is required for each channel, and thus more time is required for the measurement as compared with the third embodiment, but the phase error distribution is more accurately correctable.

### Fifth Embodiment

In a fifth embodiment of the present invention, by performing UV irradiation on a phase correcting portion only, the refractive index of the UV-irradiated phase correcting portion is slightly changed to enable fine adjustment of AWG characteristics. Each channel waveguide of the phase correcting portion may include, as described above, a wide waveguide having a length corresponding to a magnitude of a phase to be provided, or only lengths of channel waveguides of the phase correcting portion may be varied.

In the present embodiment, using the normal quartz PLC technology, a 50 GHz-96 ch flat-type AWG is manufactured. In the AWG formed using the photomask of the present invention according to the first or second embodiment, a phase correcting portion that corrects a phase error distribution of a quadratic or cubic function is provided.

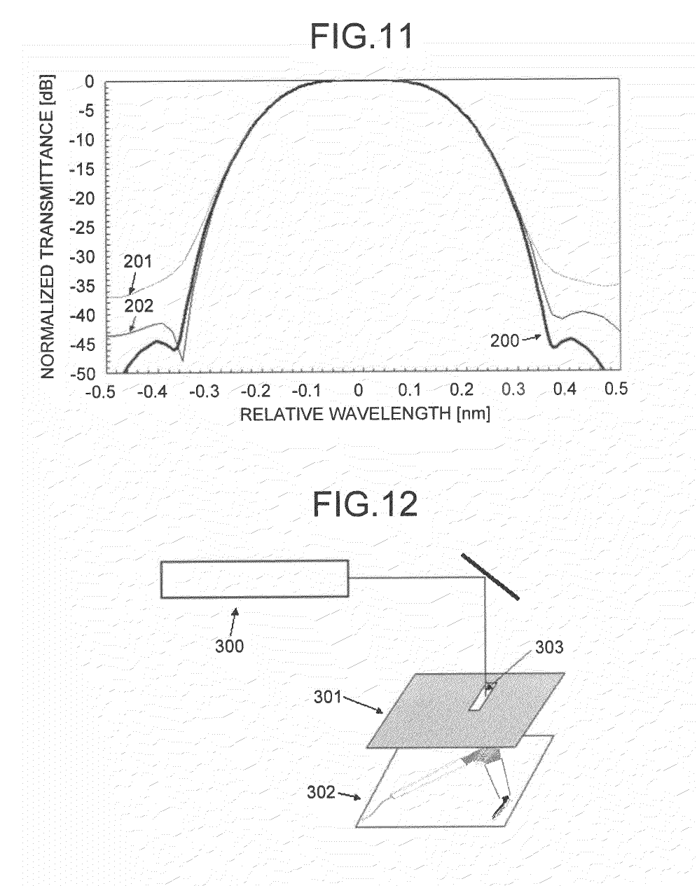

The transmission spectrum characteristics of the 50 GHz-96 ch flat-type AWGs manufactured using the mask of the present invention according to the first example are illustrated in FIG. 11. FIG. 11 illustrates the transmission spectra of the 50 GHz-96 ch flat-type AWG, which has been provided with a phase correcting portion that provides a phase of 0.7π(m−M/2)2 with respect to the m^{th} channel waveguide of the arrayed waveguide. A curve 200 represents a transmission spectrum of design values of the AWG, a curve 201 represents actual values of a transmission spectrum before UV irradiation on the phase correcting portion of the manufactured AWG, and a curve 202 represents actual values of a transmission spectrum after the UV irradiation on the phase correcting portion of the manufactured AWG.

FIG. 12 illustrates a UV irradiation configuration using an excimer laser 300, a metal shadow mask 301, an AWG chip 302, and a UV irradiation window 303. As illustrated in FIG. 12, in the UV irradiation, ArF excimer laser of 193 nm was irradiated to only the phase correcting portion of the manufactured AWG through the metal mask having the UV irradiation window for five minutes. The amount of UV irradiation and the time period of irradiation may be set as appropriate according to characteristics of the channel waveguides of the phase correcting portion.

As illustrated in FIG. 11, the transmission spectrum 202 of the AWG after the UV irradiation to its phase correcting portion has values closer to the transmission spectrum of the design values than that before the UV irradiation. As explained above, according to the present embodiment, which enables fine adjustment of the AWG characteristics by performing the UV irradiation only to the phase correcting portion, further fine adjustment becomes possible with respect to the AWGs according to the first and second embodiments, and thus the present embodiment is effective with respect to higher-end AWGs such as 50 GHz-96 ch AWGs.

Further, in the present embodiment, because the UV irradiation needs to be performed only on the entire phase correcting portion, the trouble of performing the UV irradiation individually for each channel of the arrayed waveguide depending on the amount of correction for each channel is not required, and thus a very simple and convenient method is provided.

The present embodiment relates to the 50 GHz-96 ch AWG as an example, but the invention according to the present embodiment is not necessarily implemented being limited thereto.

### Sixth Embodiment

In the fifth embodiment above, the fine adjustment of the AWG characteristics is possible by performing the UV irradiation on only the phase correcting portion. In a sixth embodiment according to the present invention, in addition to the fine adjustment of the AWG characteristics achieved by the UV irradiation on the phase correcting portion according to the fifth embodiment, further fine adjustment of the AWG characteristics is realized.

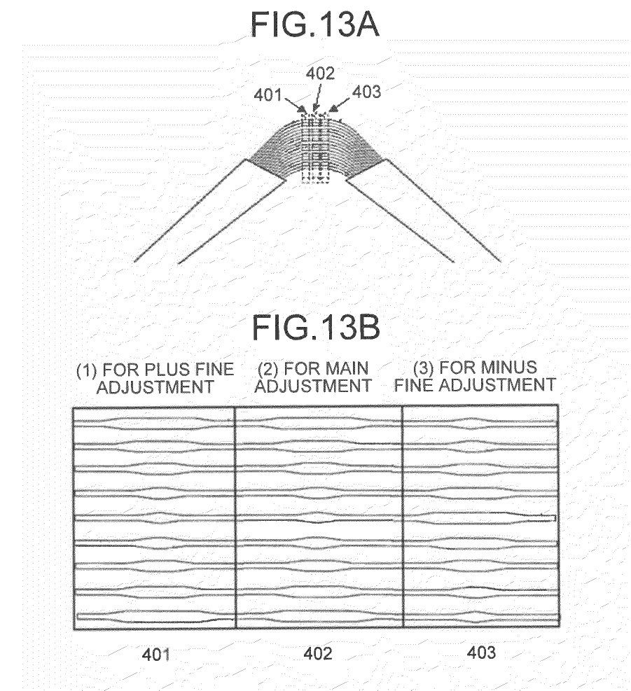

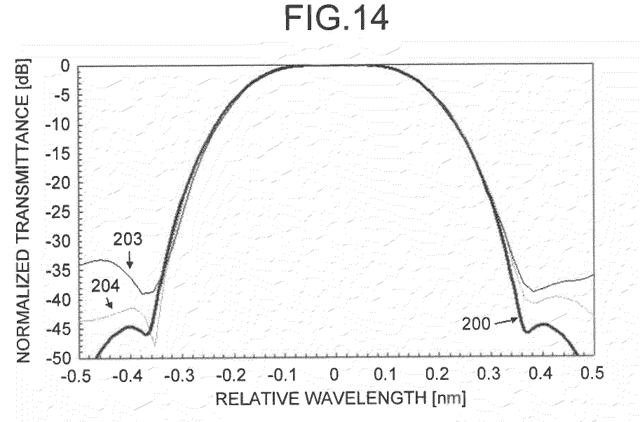

FIG. 13A is a schematic diagram of a structure of phase correcting portions of an AWG according to the sixth embodiment. The phase correcting portions include a phase correction portion 401 for plus fine adjustment, a phase correcting portion 402 for main adjustment, and a phase correcting portion 403 for minus fine adjustment. FIG. 13B is an enlarged view of the phase correction portions illustrated in FIG. 13A.

As illustrated in FIG. 13, using the normal quartz PLC technology, in a 50 GHz-96 ch flat-type AWG manufactured using the mask of the present invention according to the first example, phase correcting portions 401 to 403 that correct a phase error distribution of a quadratic or cubic function are provided in a linear waveguide portion of an arrayed waveguide. The three phase correction portions are provided in the linear waveguide portion of the arrayed waveguide so as to provide a phase (for plus fine adjustment) of 0.7π(m−M/2)² to the m^{th} channel waveguide in the phase correcting portion 401, a phase (for main adjustment) of 0.7π(m−M/2)² to the m^{th} channel waveguide in the phase correcting portion 402, and a phase (for minus fine adjustment) of −0.7π(m−M/2)² to the m^{th} channel waveguide in the phase correcting portion 403.

Each channel waveguide of the phase correcting portions, as described above, may include a wide waveguide having a length according to a magnitude of a phase to be added, or lengths of channel waveguides of the phase correcting portions may be varied.

As understood by those skilled in the art, so-called push-pull adjustment is realized by the phase correcting portions 401 to 403, and because a combination of the phases provided by the phase correcting portions 401 and 403 becomes zero, the initial phase characteristics provided to the arrayed waveguide are effectuated by the phase correcting portion 402 only.

In FIG. 14, a curve 200 represents a transmission spectrum of design values of the AWG, a curve 203 represents actual values of a transmission spectrum before UV irradiation is performed on the phase correcting portion of the manufactured AWG, and a curve 204 represents actual values of a transmission spectrum after the UV irradiation is performed on the phase correcting portion of the manufactured AWG.

Similarly to the third embodiment, to perform the UV irradiation on only one of the phase correcting portions 401 to 403 of the manufactured AWG, ArF excimer laser of 193 nm was irradiated to the phase correcting portion through the metal mask having a rectangular window for five minutes. The amount of UV irradiation is set as appropriate depending on characteristics of the channel waveguides of the phase correcting portion.

The present invention is more advantageous than the third embodiment in that when the amount of UV irradiation to the phase correcting portion 402 for main adjustment is too much or too little, by performing the UV irradiation of an appropriate amount to the phase correcting portion 401 or 403 for fine adjustment, values of the transmission spectrum of the AWG are able to be made closer to design values.

For example, if a certain amount of UV irradiation is performed on the phase correcting portion 402 for main adjustment but this irradiation fails to sufficiently make the values of the transmission spectrum of the AWG close to the design values because of the amount of UV irradiation being too small, by further performing an adequate amount of UV irradiation on the phase correcting portion 401 for plus fine adjustment, the values of the transmission spectrum of the AWG are able to be made closer to the design values. Alternatively, if the amount of UV irradiation on the phase correcting portion 402 for main adjustment is too much and the values of the transmission spectrum of the AWG deviate from the design values, by further performing an adequate amount of UV irradiation on the phase correcting portion 403 for minus fine adjustment, the values of the transmission spectrum of the AWG are able to be made closer to the design values. Those skilled in the art would understand that the invention according to the present embodiment may be implemented without being limited to the examples mentioned here.

The invention according to the present embodiment is not limited only to the configuration in which three phase correcting portions 401 to 403 are provided in the linear waveguide portion of the arrayed waveguide as illustrated in FIG. 13. For example, five phase correcting portions, which include two phase correcting portions for plus fine adjustment, one phase correcting portion for main adjustment, and two phase correcting portions for minus fine adjustment, may be provided. That is, as long as the sum of phases provided by the phase correcting portions for fine adjustment becomes zero, and the initial phase characteristics provided to the arrayed waveguide are able to achieve the effects of only the phase correcting portion for main adjustment, plural phase correcting portions may be provided.

According to an embodiment of the present invention, it is possible to obtain a transmission spectrum close to design values and to realize an arrayed waveguide grating suitable for mass production.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An arrayed waveguide grating, comprising:
at least one first waveguide;
a first slab waveguide connected to the at least one first waveguide;
a plurality of second waveguides;
a second slab waveguide connected to the plurality of second waveguides; and
an arrayed waveguide including:
M channel waveguides connected between the first slab waveguide and the second slab waveguide, wherein M is a natural number; and
a phase correcting portion configured to provide a predetermined phase to at least a part of the M channel waveguides by one or both of a width and a length of the at least the part of the M channel waveguides being changed.

2. The arrayed waveguide grating according to claim 1, wherein
the phase correcting portion is configured to provide a phase of a(m−M/2)²+b(m−M/2)+c to the m^{th} channel waveguide of the M channel waveguides,
a, b, and c are constants of values within a range of −2π to 2π in radians, and
1≦m≦M.

3. The arrayed waveguide grating according to claim 1, wherein
the phase correcting portion is configured to provide a phase of a(m−M/2)³+b(m−M/2)²+c(m−M/2)+d to the m^{th} channel waveguide of the M channel waveguides,
a, b, c, and d are constants of values within a range of −2π to 2π in radians, and
1≦m≦M.

4. The arrayed waveguide grating according to claim 1, wherein
the phase correcting portion includes a wide waveguide having a width W2 larger than a basic waveguide width W1 in each of a part or all of the M channel waveguides, and
the predetermined phase is adjusted by one or both of a length and a width of the wide waveguide being changed.

5. The arrayed waveguide grating according to claim 1, wherein the phase correcting portion is configured such that a length of each channel waveguide is different from a length of a design value of that channel waveguide for a part or all of the M channel waveguides.

6. The arrayed waveguide grating according to claim 1, wherein the M channel waveguides include a linear waveguide portion and the phase correcting portion is provided in the linear waveguide portion.

7. The arrayed waveguide grating according to claim 1, wherein
the M channel waveguides include a first phase correcting portion for fine adjustment and a second phase correcting portion for fine adjustment,
each of the first and second phase correcting portions for fine adjustment includes a wide waveguide having a width wider than a basic waveguide width in a part or all of the M channel waveguides,
the predetermined phase is adjusted by one or both of a length and a width of the wide waveguide being changed, and
each of the lengths of the wide waveguides of the first and second phase correcting portions for fine adjustment is defined such that a sum of phases provided by the first and second phase correcting portions for fine adjustment becomes zero.

8. The arrayed waveguide grating according to claim 7, wherein each of the phase correcting portion and the first phase correcting portion for fine adjustment is configured to provide a phase of a(m−M/2)²+b(m−M/2)+c to the m^{th} channel waveguide of the M channel waveguides,
the second phase correcting portion for fine adjustment is configured to provide a phase of −a(m−M/2)²−b(m−M/2)−c to the m^{th} channel waveguide of the M channel waveguides, and a, b, and c are constants of values within a range of −2π to 2π in radians.

9. The arrayed waveguide grating according to claim 7, wherein
each of the phase correcting portion and the first phase correcting portion for fine adjustment is configured to provide a phase of a(m−M/2)3+b(m−M/2)2+c(m−M/2)+d to the m^{th} channel waveguide of the M channel waveguides,
the second phase correcting portion for fine adjustment is configured to provide a phase of −a(m−M/2)³−b(m−M/2)²−c(m−M/2)−d to the m^{th} channel waveguide of the M channel waveguides, and
a, b, c, and d are constants of values within a range of −2π to 2π in radians.

10. The arrayed waveguide grating according to claim 7, wherein
the M channel waveguides include a linear waveguide portion, and
the phase correcting portion and the first and second phase correcting portions for fine adjustment are provided in the linear waveguide portion.

11. A method of manufacturing the arrayed waveguide grating according to claim 1, comprising:
preparing the arrayed waveguide grating; and
performing UV irradiation on the phase correcting portion.

12. A method of manufacturing the arrayed waveguide grating according to claim 7, comprising:
preparing the arrayed waveguide grating;
performing UV irradiation on the phase correcting portion; and
performing UV irradiation on one or both of the first and second phase correcting portions for fine adjustment to make a fine adjustment on the phase or phases to be provided, after performing the UV irradiation on the phase correcting portion.
